(19) United States
(12) Patent Application Publication
(10) Pub. No.: US 2019/0336965 A1
(43) Pub. Date: Nov. 7, 2019

(54) CAPPED CONTAINER

(71) Applicants: Toho Technology Corporation, Naka-ku (JP); Shinsei Co., Ltd., Kitanagoya (JP)

(72) Inventors: Takuya Kurimoto, Nagoya-shi (JP); Kenji Tahara, Toyoake-shi (JP)

(21) Appl. No.: 16/405,808

(22) Filed: May 7, 2019

Related U.S. Application Data
(60) Provisional application No. 62/667,775, filed on May 7, 2018.

(51) Int. Cl. B01L 3/00; B65D 51/24; B65D 41/18

(52) U.S. Cl. CPC B01L 3/508; B65D 51/24; B01L 2300/04; B01L 2200/025; B01L 2200/0689; B65D 41/185

(57) ABSTRACT

A pathogen container having a cap, a receptacle and a specimen collection member. The cap attaches to the receptacle creating a water and air tight enclosure. The receptacle has a plurality of retention members that engage with a plurality of openings in the cap to retain the cap to the receptacle. At least one alignment member on the receptacle corresponds with at least one alignment recession in the cap. The receptacle has an annular ridge extending radially outward proximate an open end of the receptacle. The cap has an annular lip that extends outward from the edge of an open end of the cap.

### CROSS-REFERENCE TO RELATED APPLICATION

This application claims the benefit of U.S. Provisional Application No. 62/667,775, filed May 7, 2018, the contents of which are herein incorporated by reference in their entirety.

### BACKGROUND

This application discloses a capped pathogen sample container. Pathogen sample containers are used to securely contain specimens of pathogens during testing or detection. A need exists amongst companies that test pathogen samples to securely contain a collected specimen that has been transported from the sampling location to a testing facility. In doing so, it is often important that the sample be contained in a secure, sealed container that prevents the specimen, including a pathogen from escaping the container into the surrounding environment. Likewise, once sealed, the container should prevent external gases, fluids or other pathogens from entering the container. Pathogen sample containers must also be able to withstand the build up of internal pressure to ensure that the cap will not leak or break the seal when exposed to internal pressure that may be generated by expansion of the gasses inside of the container.

In certain situations, a company may obtain a specimen via a specimen collection device such as a swab and transport it in a first container and then transfer the specimen to a second container. In certain situations, a company may transport the collection device in a recloseable bag, and then transfer the collection device to a more secure testing container. A need exists for a collection device that can be transported in a first container and then transferred to a secure second container for testing. Likewise a need exists for a collection device that can easily be transferred from a first temporarily sealed container to a second permanently sealed container for testing. In the present invention, a cap can be sealed against the top of a first container, such as a tube shaped container for transport but where the cap is removable from the first container. The specimen, cap and collector may then be transferred to a second detection or testing container, into which an assay is placed with the sample to test the sample. It is desirable that the second container have a non-removable cap so that the assay and sample cannot escape from the container or become contaminated from the outside environment. A need exists for a detection container that, once sealed, cannot have the cap removed and replaced. A need further exists for a non-breakable, cost effective pathogen sample container with a cap that can be securely attached to a receptacle portion to seal the container for pathogen detection.

### BRIEF DESCRIPTION OF THE DRAWINGS

FIG. 1 shows an isometric view of a receptacle of a container according to an embodiment of the invention.

FIG. 2 shows another isometric view of the receptacle of FIG. 1.

FIG. 3 shows a side view of the receptacle of FIG. 1.

FIG. 4 shows a cross section of the side view of the receptacle of FIG. 1.

FIG. 5 shows an expanded cross sectional side view of an open end of the receptacle of FIG. 1.

FIG. 6 shows a front view of the receptacle of FIG. 1.

FIG. 7 shows a back view of the receptacle of FIG. 1.

FIG. 8 shows a cross section of a side view of the receptacle of FIG. 1.

FIG. 9 shows an isometric view of a cap of a container according to an embodiment of the invention.

FIG. 10 shows a side view of the cap of FIG. 9.

FIG. 11 shows a side view of the cap of FIG. 10.

FIG. 12 shows a cross sectional side view of the cap of FIG. 9.

FIG. 13 shows a cross sectional side view of the cap of FIG. 9.

FIG. 14 shows a top view of the cap of FIG. 9.

FIG. 15 shows a back view of the cap of FIG. 9.

FIG. 16 shows an isometric view of a cap of a container according to an embodiment of the invention.

FIG. 17 shows an isometric view of the cap of FIG. 16.

FIG. 18 shows a side view of the cap of FIG. 16.

FIG. 19 shows a side view of the cap of FIG. 16.

FIG. 20 shows a cross sectional side view of the cap of FIG. 16.

FIG. 21a shows a side view of a container comprising an assembled cap, specimen collection member, and receptacle according to an embodiment of the present invention.

FIG. 21b shows the cap and specimen collection member of FIG. 21a with the receptacle removed.

FIG. 22 shows a cross sectional view of the cap of FIG. 16 with an O-ring.

### BRIEF SUMMARY OF INVENTION

The present invention is directed to an air and water tight pathogen container comprising a receptacle and cap combined to create an enclosure. The cap is retained to the receptacle to withstand internal pressure and prevent inadvertent removal of the cap and exposure to the pathogen contained therein. The receptacle has an open end, a closed end opposite the open end, and a sidewall connecting the receptacle open end to the receptacle closed end.

The receptacle has at least one alignment member extending from the receptacle sidewall proximate the receptacle open end and extending in the direction of the receptacle closed end. The receptacle also includes a plurality of ramped retention members extending outward from the receptacle sidewall and positioned proximate the receptacle open end. The cap has an open end, a closed end and a cap sidewall connecting the open end and the closed end and defining an open space. The cap further includes an annular channel defined by an interior surface of the cap sidewall on one side and an interior annular cap member extending perpendicular to an interior surface of the cap on the other side. The cap further includes at least one elongated alignment recession formed in the cap sidewall and a plurality of openings formed in the cap sidewall. A specimen collection member is attached to the cap and extends beyond the open end of the cap. When the cap is assembled to the receptacle, the open end of the receptacle is positioned in the annular channel to seal the cap to the receptacle, the elongated alignment recessions receive the alignment members to prevent rotation of the cap relative to the receptacle and to align the retention members to the openings. The openings in the cap sidewall engage the ramped retention members to retain the cap to the receptacle.

In certain embodiments, the receptacle sidewall has a circumferential edge at the receptacle open end and the cap has an annular lip extending radially outward from the sidewall proximate the cap open end.

### DETAILED DESCRIPTION OF THE INVENTION

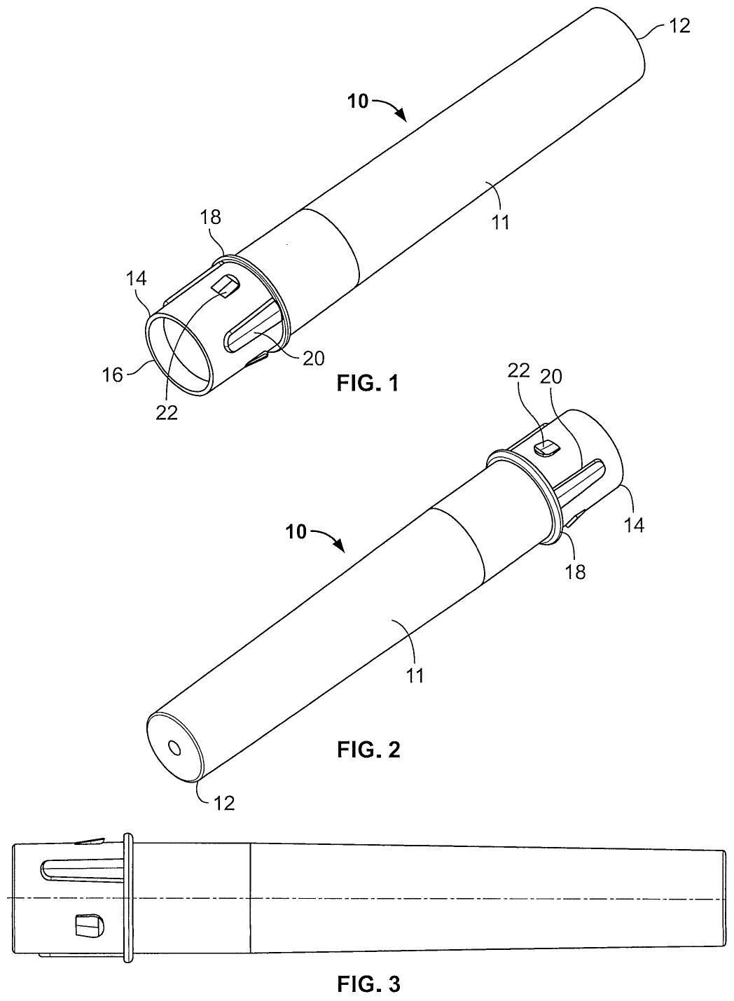

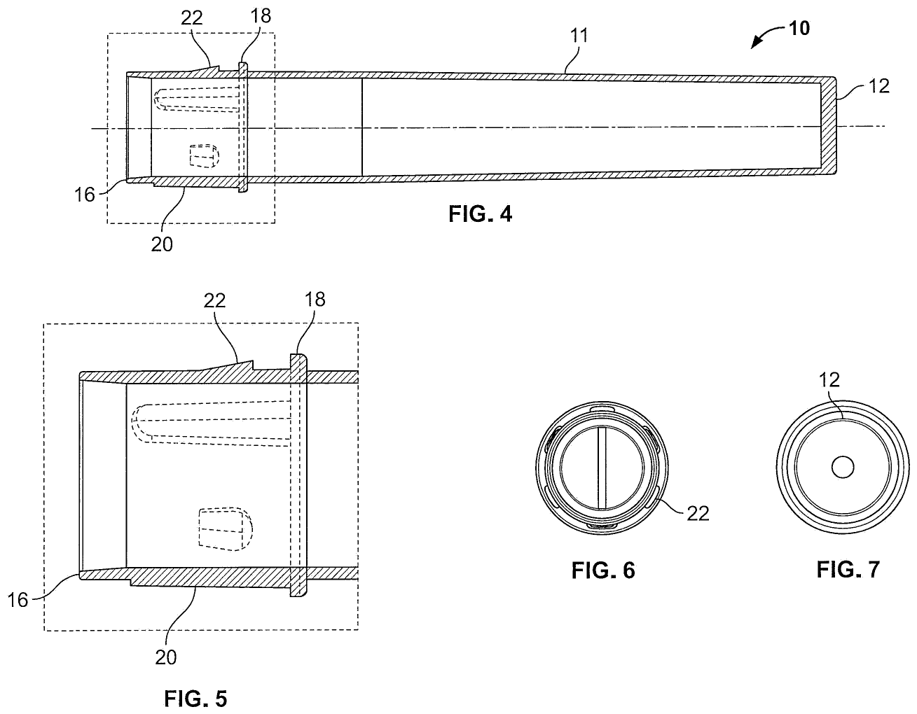

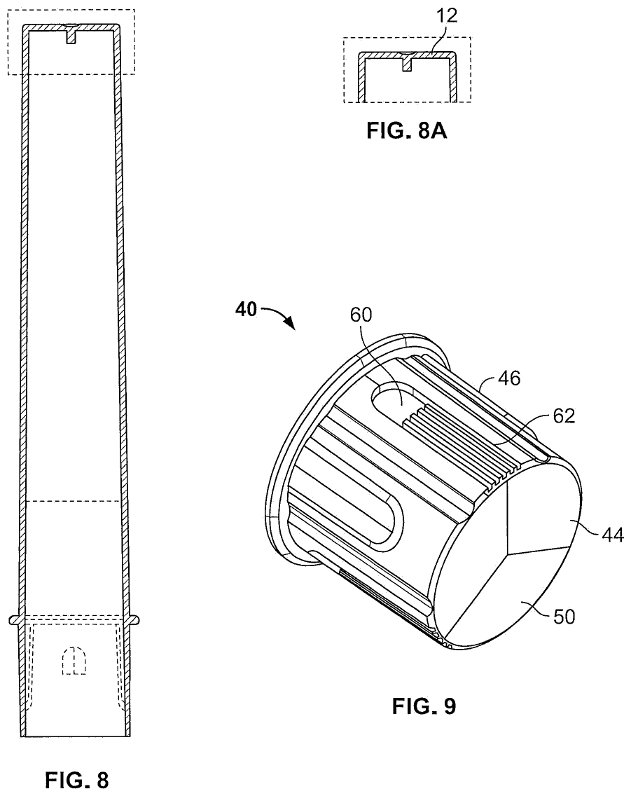

FIGS. 1-8 show a receptacle 10 according to an embodiment of the invention. Receptacle 10 has a sidewall 11 connecting a closed end 12 and an open end 14 opposite the closed end 12. Sidewall 11 and closed end 12 define an open space within receptacle 10. Sidewall 11 has a thickness that tapers as it reaches open end 14. Sidewall 11 terminates in a circumferential edge 16 at open end 14.

As shown in FIGS. 1-5, a number of features extend outward from the sidewall 11 proximate the open end 14 for engaging a cap, described below. An annular ridge 18 extends approximately perpendicularly outward from the sidewall 11 proximate the open end 14. A plurality of alignment members 20 are positioned proximate the open end 14 on the sidewall 11 of the receptacle 10. Alignment members 20 extend outward from the sidewall 11 proximate the open end 14 and extend in the direction of the closed end 12, terminating when they intersect with the annular ridge 18. The embodiment shown in FIGS. 1, 2, 3 and 5 show three equally spaced alignment members, however more or fewer alignment members may be used as will be appreciated by one of skill in the art.

As shown in FIGS. 1-5, a plurality of ramped retention members 22 extend outward from the sidewall 11 of the receptacle 10. Ramped retention members 22 are between the annular ridge 18 and the open end 14. Ramped retention members 22 have a first edge proximate the open end and gradually ramp radially outward from the sidewall 11 at an angle. Ramped retention members 22 have a second end extending approximately perpendicular to the sidewall a first distance from the sidewall 11. In one embodiment, the height of the second end relative to the sidewall 11 is approximately 0.18 mm. The second end of the retention member 22 may have an arcuate profile when viewed perpendicularly from the sidewall.

In a preferred embodiment, the receptacle has three equally spaced retention members 22, as shown in FIG. 6. In a preferred embodiment, the retention members 22 are interspersed between the alignment members 20, such that the retention members 22 and the alignment members 20 are alternating around the sidewall 11 of the receptacle 10 proximate the open end 14.

The receptacle 10 may be made from polypropylene or another suitable non-permeable material. The receptacle may be injection molded according to techniques known in the art.

FIGS. 9-15 show a first embodiment of a cap 40 of a container according to the present invention. Cap 40 attaches to receptacle 10 to seal the receptacle and define an enclosed space within the receptacle 10.

Cap 40 has an open end 42 and a closed end 44 connected by a sidewall 46 defining an open space within the sidewall 46. Open end 42 has an annular lip 48 that extends radially outward and generally perpendicular to the sidewall 46. When the cap 40 is assembled to the receptacle 10, the annular lip 48 abuts the annular ridge 18 of the receptacle 19, preventing the cap 40 from being over-inserted onto the receptacle 10.

Closed end 44 has an exterior surface 50 and an interior surface 52 opposite the exterior surface. An internal annular cap member 56 extends generally perpendicularly to the interior surface 52 of the closed end 44, defining an annular channel 56 between the interior surface of sidewall 54 and the internal annular cap member 56. The annular channel has a width between the interior surface of the sidewall 45 and the outer surface of the annular channel 56 that is slightly smaller than the thickness of the receptacle sidewall 11 at the open end 14 of the receptacle 10. When the cap 40 is attached to the receptacle 10, the circumferential edge 16 of the receptacle is inserted into the annular channel 56 and the interior and exterior surfaces of the receptacle sidewall 11 abut the interior surface of the cap sidewall 46 and the interior surface of the internal annular cap member 56, respectively, thereby forming a gas and fluid tight seal between the cap 40 and the receptacle 10. The circumferential edge 16 of the receptacle abuts the interior surface 52 of the cap closed end, thereby further creating a seal between the cap 40 and the receptacle 10.

As shown in FIGS. 12 and 13, a plurality of alignment recessions 58 are defined within cap sidewall 46. The alignment recessions 58 extend from the open end of the cap 42 longitudinally into the cap toward the closed end 44. The shape of the alignment recessions 58 corresponds approximately to the shape of the alignment members 22 on the cap 10. When the cap 40 is inserted onto the receptacle 10, the alignment recessions 58 receive the alignment members 22 on the receptacle 19 and guide the cap 40 onto the receptacle 10. The sidewall 46 of the cap 40 may also extend radially outward corresponding to the alignment recessions 58 to prevent the cap 40 from being overly thinned where the alignment recessions 58 are positioned in the cap 40.

The alignment recessions 58 also serve to align the attachment members 22 on the receptacle 10 to attachment openings 60. A plurality of attachment openings 60 are defined in the sidewall 46 of the cap 40. The attachment openings 60 are generally shaped to correlate to the shape of the attachment members 22. In particular, the attachment openings 60 have a curved surface perpendicular to the outer and inner surfaces of the sidewall on the end of the attachment opening proximate the open end 42 of the cap 10. The curved surface of the attachment openings abuts the curved surface of the attachment members 22 to prevent the cap 40 from being removed from the receptacle 40 without destruction of the cap 10.

As shown in FIGS. 9 and 11, a plurality of ridges 62 extend longitudinally along the exterior surface of the cap sidewall 46 from the attachment opening 60 to the closed end 44 of the cap. Ridges 62 enhance the ability of a user to grip and rotate the cap 40.

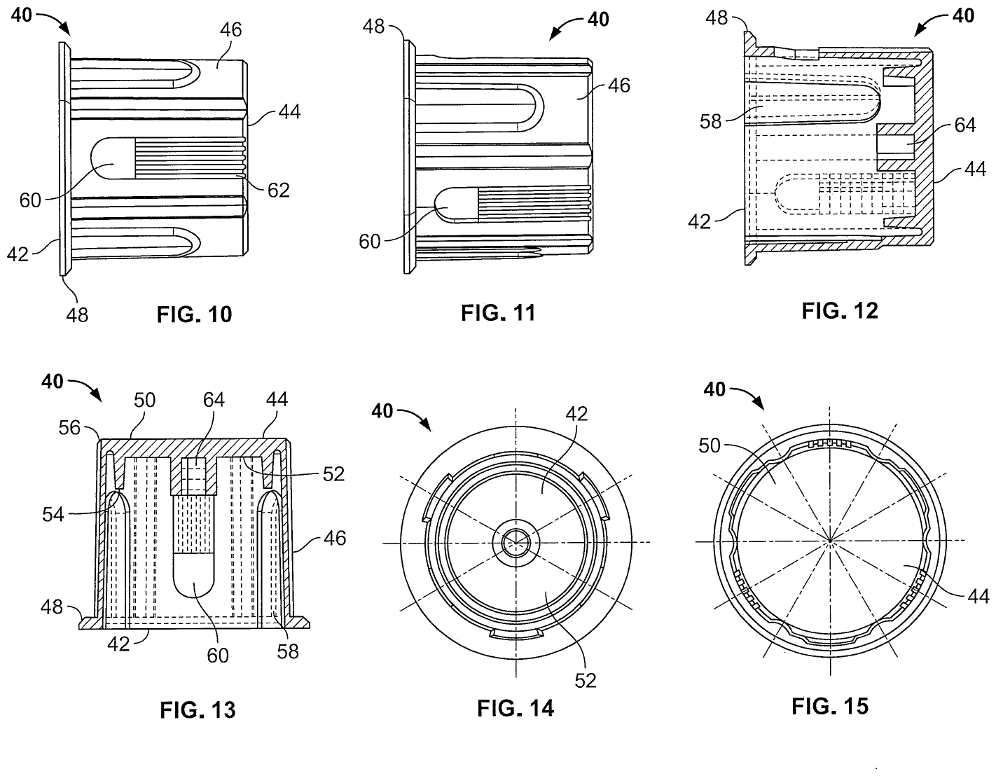

An annular center member 64 extends longitudinally into the cap 40 from the internal surface 52 of the closed end of the cap. The annular center member 64 defines an opening within the cap 40 for receiving a specimen collection member (not shown in FIGS. 9 and 10).

Cap 40 may be made from polypropylene or other non-permeable plastics or other suitable materials.

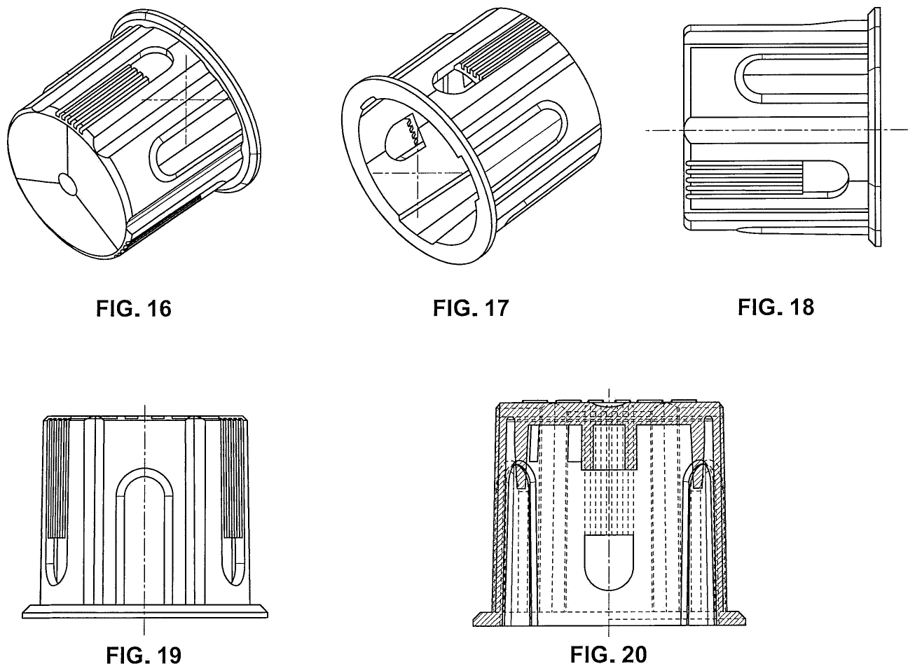

Another embodiment of a cap is shown in FIGS. 16-20.

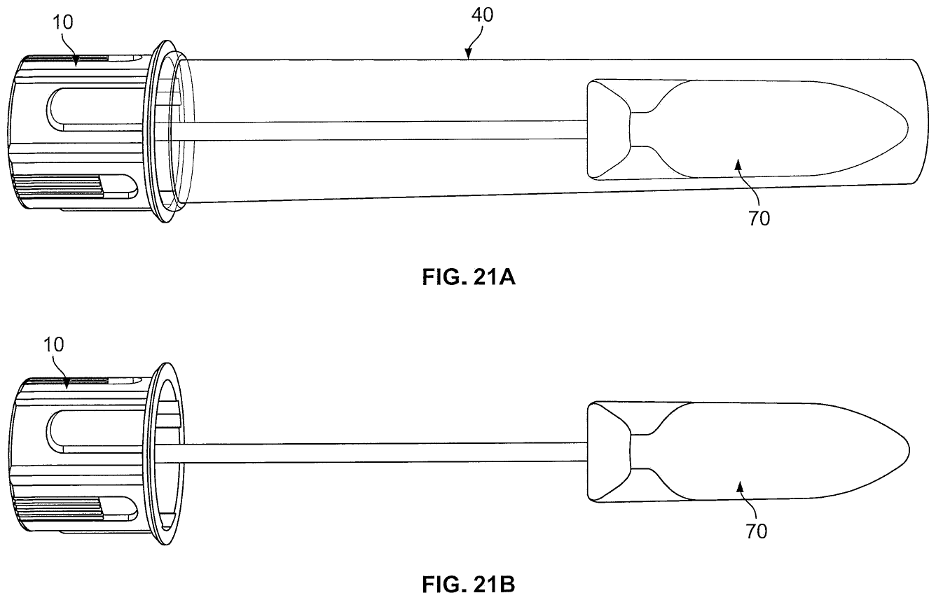

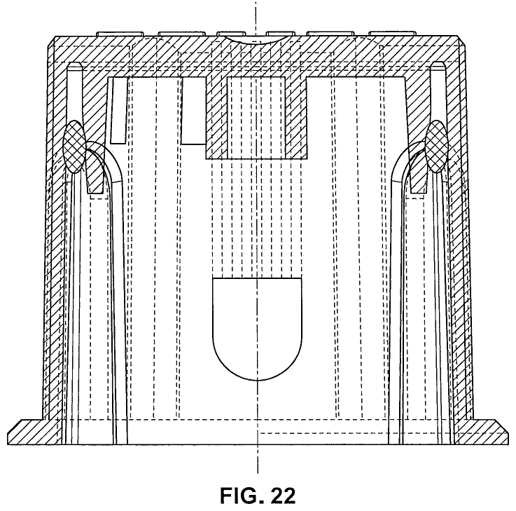

FIG. 21a shows a container comprised of cap 40 with a specimen collection member 70 attached to the cap 40 and the cap attached to receptacle 10. As shown in FIG. 21a, cap 40 extends over and seals to the open end of the receptacle 10 and specimen collection member 70 is enclosed within the sealed space defined by the cap 40 and receptacle 10. As shown in FIG. 21a, in a preferred embodiment, the distance that the annular ridge 18 of the receptacle 19 extends from the receptacle sidewall is preferably greater than ⅔ of the distance that the annular lip 48 of the cap extends from the cap sidewall 46. This feature further prevents users from pressing on or prying on the cap open end 42 to try to remove the cap 40 from the receptacle 10.

FIG. 21b shows the specimen collection member 70 attached to the cap 40. The specimen collection member 70 is received by the annular center member 64 (shown in FIGS. 9 and 10). The specimen collection member extends away from the interior surface 52 of the closed end of the cap 40. Specimen collection member 70 is shown as a swab, but could encompass a scraper, tube or other longitudinal member for collecting a specimen as would be known in the art.

FIG. 22 shows a cross section of an alternate embodiment of a cap according to the invention. In this embodiment, a seal, for example an elastomeric o-ring, is positioned within the annular channel 56 between the interior surface of sidewall 54 and the internal annular cap member 56. When the cap 40 is attached to the receptacle 10, the circumferential edge 16 of the receptacle is inserted into the annular channel 56 and abuts the o-ring, thereby forming a gas and fluid tight seal between the cap 40, the o-ring and the receptacle 10.

When the cap 40 is attached to the receptacle 10 as described herein, the assembled container is able to withstand an internal pressure of up to 60 pounds per square inch for over 4 minutes.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof. Modifications and variations can be made to the present security assembly without departing from the spirit and scope of the invention as defined by the following claims or their equivalents. Hence, unless changes otherwise depart from the scope of the invention, the changes should be construed as being included herein.

We claim:

1. A pathogen container comprising:
a receptacle having an open end, a closed end opposite the open end, and a sidewall connecting the receptacle open end to the receptacle closed end, wherein the receptacle sidewall terminates in a circumferential edge at the receptacle open end;
an annular ridge extending from the receptacle sidewall proximate the receptacle open end;
at least one alignment member extending from the receptacle sidewall proximate the receptacle open end and extending in the direction of the receptacle closed end, the at least one alignment member ending at an intersection with the annular ridge;
a plurality of ramped retention members extending outward from the receptacle sidewall and positioned between the annular ridge and the receptacle open end;
a cap attachable to the receptacle to seal off and define an enclosed space within the receptacle, the cap having an open end, a closed end and a cap sidewall connecting the open end and the closed end and defining an open space;
an annular lip extending radially outward from the cap sidewall proximate the cap open end;
an annular channel defined by an interior surface of the cap sidewall on a first side and an interior annular cap member extending perpendicular to an interior surface of the cap on a second side opposite the first side;
at least one elongated alignment recession formed in the cap sidewall;
a plurality of openings formed in the cap sidewall; and
a specimen collection member attached to the cap and extending beyond the open end of the cap.

2. The pathogen container of claim 1, wherein the thickness of the receptacle sidewall tapers proximate the receptacle open end.

3. The pathogen container of claim 1, wherein the at least one alignment member is a plurality of alignment members, each alignment member positioned between two of the retention members.

4. The pathogen container of claim 1, wherein the ramped retention members have a first end proximate the receptacle open end and a second end extending approximately perpendicular to the receptacle sidewall, the second end of the retention member having an arcuate surface.

5. The pathogen container of claim 4, wherein the attachment openings have a curved surface perpendicular to the outer and inner surfaces of the cap sidewall on the end of the attachment opening proximate the cap open end.

6. The pathogen container of claim 1, wherein the attachment openings are generally sized and shaped to correspond to the size and shape of the retention members for receiving the retention members.

7. The pathogen container of claim 1 further comprising a seal positioned in the annular channel between the interior surface of the closed cap end and the receptacle edge.

8. The pathogen container of claim 1, wherein the attachment of the cap to the receptacle creates a water and gas impermeable enclosed space within the container.

9. The pathogen container of claim 1, wherein the at least one elongated alignment recession has an end at the open end of the cap.

10. The pathogen container of claim 9, wherein the at least one elongated alignment recession has a shape corresponding to the shape of the at least one alignment member.

11. The pathogen container of claim 1, wherein the specimen collector is attached to the interior surface of the closed end of the cap radially inward from the annular cap member.

12. A pathogen container comprising:
a receptacle having an open end, a closed end opposite the open end, and a sidewall connecting the receptacle open end to the receptacle closed end, wherein the receptacle sidewall terminates in a circumferential edge at the receptacle open end;
at least one alignment member extending from the receptacle sidewall proximate the receptacle open end and extending in the direction of the receptacle closed end;
a plurality of ramped retention members having a first end proximate the open end and ramping radially outward from the sidewall along the length of the receptacle at an angle;
a cap attachable to the receptacle to seal off and define an enclosed space within the receptacle, the cap having an open end, a closed end and a cap sidewall connecting the open end and the closed end and defining an open space;
an interior annular cap member extending from an interior surface of the cap closed end generally perpendicular to the cap sidewall, the interior annular cap member having an interior sidewall and an exterior sidewall;
at least one elongated alignment recession formed in the cap sidewall;
a plurality of openings formed in the cap sidewall; and
a specimen collection member attached to the cap and extending beyond the open end of the cap.

13. A pathogen container cap for attachment to a receptacle having an open end, a closed end opposite the open end, and a sidewall connecting the receptacle open end to the receptacle closed end, wherein the receptacle sidewall terminates in a circumferential edge at the receptacle open end, the receptacle further having an annular ridge extending from the receptacle sidewall proximate the receptacle open end, at least one alignment member extending from the receptacle sidewall proximate the open end, and a plurality of ramped retention members extending outward from the receptacle sidewall and positioned between the annular ridge and the receptacle open end, the pathogen container cap comprising:
an open end, a closed end and a cap sidewall connecting the open end and the closed end and defining an open space;
an annular lip extending radially outward from the sidewall proximate the cap open end;
an annular channel defined by an interior surface of the cap sidewall on one side and an interior annular cap member extending perpendicular to an interior surface of the cap on the other side;
at least one elongated alignment recession formed in the cap sidewall;
a plurality of openings formed in the cap sidewall; and
a specimen collection member attached to the cap and extending beyond the open end of the cap.

14. The cap of claim 13 wherein the attachment openings have a curved surface perpendicular to the outer and inner surfaces of the cap sidewall on the end of the attachment opening proximate the cap open end.

15. The cap of claim 13 further comprising a seal positioned in the annular channel between the interior surface of the closed cap end and the receptacle edge.

16. The cap of claim 13, wherein the interior annular cap member has an interior sidewall and an exterior sidewall.

17. A pathogen container receptacle for receiving a cap having an open end, a closed end and a cap sidewall connecting the open end and the closed end, an annular lip extending radially outward from the sidewall proximate the cap open end, at least one elongated alignment recession formed in the cap sidewall, a plurality of openings formed in the cap sidewall, and a specimen collection member attached to the cap and extending beyond the open end of the cap, the receptacle comprising:
an open end, a closed end opposite the open end, and a sidewall connecting the receptacle open end to the receptacle closed end, wherein the receptacle sidewall terminates in a circumferential edge at the receptacle open end;
an annular ridge extending from the receptacle sidewall proximate the receptacle open end;
at least one alignment member extending from the receptacle sidewall proximate the receptacle open end and extending in the direction of the receptacle closed end, the at least one alignment member ending at an intersection with the annular ridge; and
a plurality of ramped retention members extending outward from the receptacle sidewall and positioned between the annular ridge and the receptacle open end.

18. The receptacle of claim 17, wherein the ramped retention members have a first end proximate the receptacle open end and a second edge extending approximately perpendicular to the receptacle sidewall, the second end having an arcuate surface.

19. A pathogen container comprising:
a receptacle having an open end, a closed end opposite the open end, and a sidewall connecting the receptacle open end to the receptacle closed end, wherein the receptacle sidewall terminates in a circumferential edge at the receptacle open end;
an annular ridge extending from the receptacle sidewall proximate the receptacle open end;
at least one alignment member extending from the receptacle sidewall proximate the receptacle open end and extending in the direction of the receptacle closed end, the at least one alignment member ending at an intersection with the annular ridge;
a plurality of ramped retention members extending outward from the receptacle sidewall and positioned between the annular ridge and the receptacle open end;
a cap attachable to the receptacle to seal off and define an enclosed space within the receptacle, the cap having an open end, a closed end and a cap sidewall connecting the open end and the closed end and defining an open space;
an annular lip extending radially outward from the sidewall proximate the cap open end;
an annular channel defined by an interior surface of the cap sidewall on a first side and an interior annular cap member extending perpendicular to an interior surface of the cap on a second side opposite the first side;
at least one elongated alignment recession formed in the cap sidewall;
a plurality of openings formed in the cap sidewall;
a specimen collection member attached to the cap and extending beyond the open end of the cap; and
wherein when the cap is assembled to the receptacle, the open end of the receptacle is positioned in the annular channel to create an air and water tight seal between the cap and receptacle, the at least one elongated alignment recession receives the at least one alignment member, and the plurality of openings in the cap sidewall engage the plurality of ramped retention members to retain the cap to the receptacle such that the cap cannot be removed without destruction.

20. The pathogen container of claim 19, wherein the interface of the annular lip to the annular ridge prevents over insertion of the cap onto the receptacle.

21. The pathogen container of claim 19, wherein the annular ridge extends a distance from the receptacle sidewall that is greater than ⅔ of the distance that the annular lip extends from the cap sidewall.
